(19) United States
(12) Patent Application Publication
(10) Pub. No.: US 2012/0124242 A1
(43) Pub. Date: May 17, 2012

(54) SERVER AND METHOD FOR TESTING PXE FUNCTION OF NETWORK INTERFACE CARD

(75) Inventors: XIAO-FEI CHEN, Shenzhen City (CN); JUN-MIN CHEN, Shenzhen City (CN); ZHI-JIAN LONG, Shenzhen City (CN); LE LIN, Shenzhen City (CN); MING-XIANG HU, Shenzhen City (CN)

(73) Assignees: HON HAI PRECISION INDUSTRY CO., LTD., Tu-Cheng (TW); HONG FU JIN PRECISION INDUSTRY(Shenzhen) CO., LTD., Shenzhen City (CN)

(21) Appl. No.: 13/192,478

(22) Filed: Jul. 28, 2011

(30) Foreign Application Priority Data
Nov. 16, 2010 (CN) 201010546399.5

(51) Int. Cl. G06F 15/16

(52) U.S. Cl. 709/250

(57) ABSTRACT

In a method for testing a preboot execution environment (PXE) function of a NIC of a server, an IP address is allocated for the NIC by sending a DHCP offer message to the NIC in response to receiving a DHCP discover message from the NIC. TFTP parameters are provided to the NIC by sending a DHCP ACK message to the NIC in response to receiving a DHCP request message from the NIC. A connection based on a MTFTP or a TFTP between the BMC and the NIC is established according to the TFTP parameters. A PXE image file is provided to the NIC for downloading through the connection in response to receiving a request for downloading the PXE image file from the NIC, and the downloaded PXE image file is executed to test whether the PXE function of the NIC is normal.

### BACKGROUND

1. Technical Field

Embodiments of the present disclosure relate generally to network interface card (NIC) testing, and more particularly, to a server and method for testing preboot execution environment (PXE) function of a NIC of the server.

2. Description of Related Art

Preboot execution environment (PXE) is an environment to boot computing devices, such as personnel computers and servers, by remotely downloading and executing an image file from a remote terminal. Many network interface cards (NICs) can implement the PXE function. In a method for testing the PXE function of a NIC, the NIC is connected to a server installed with a dynamic host configuration protocol (DHCP) service. In order to avoid influencing other services based on the server, a special network for testing the PXE function of the NIC requires to be established. However, it is time consuming and costly to establish the special network.

### BRIEF DESCRIPTION OF THE DRAWINGS

FIG. 1 is a block diagram of one embodiment of a server.

FIG. 2 is a block diagram of one embodiment of functional modules of a PXE testing system of the server.

FIG. 3 is a flowchart of one embodiment of a method for testing a PXE function of a network interface card (NIC) of the server of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

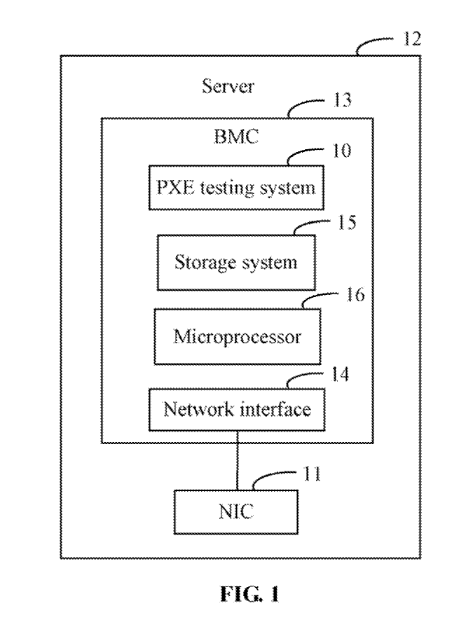

FIG. 1 is a block diagram of one embodiment of a server 12. In the embodiment, the server 12 includes a baseboard management controller (BMC) 13, and a network interface card (NIC) 11. In the embodiment, a dynamic host configuration protocol (DHCP) service is installed on the server 12. The NIC 11 is installed with a PXE boot ROM to provide PXE functions. The BMC 13 is operable to test a preboot execution environment (PXE) function of the NIC 11. The NIC 11 can be installed on other computing devices, such as, personnel computers. It should be apparent that FIG. 1 is only one example of the server 12 and it can include more or fewer components than shown in the embodiment, or a different configuration of the various components.

In one embodiment, the BMC 13 includes a PXE testing system 10, a network interface 14, a storage system 15, and a microprocessor 16. The BMC 13 is connected with the NIC 11 through the NIC interface 14, and communicates with the NIC 11 to test the PXE function of the NIC 11.

The storage system 15 stores a predetermined PXE image file. The PXE image file may be remotely downloaded to a memory of the server 12 and executed to test whether the PXE function of the NIC 11 is normal. In addition, the storage system 15 further stores one or more programs, such as programs of a firmware or other applications of the BMC 13, and executed by the microprocessor 16 to provide functions of the BMC 13. In one embodiment, the storage system 15 may be a random access memory (RAM) for temporary storage of information, and/or a read only memory (ROM) for permanent storage of information. In other embodiments, the storage system 15 may also be an external storage device, such as a hard disk, a storage card, or a data storage medium.

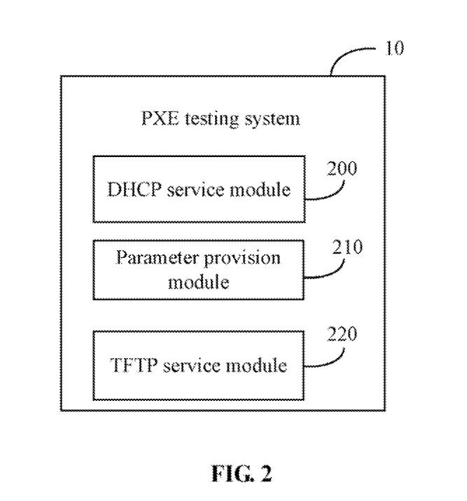

FIG. 2 is a block diagram of one embodiment of functional modules of the PXE testing system 10 of FIG. 1. The PXE testing system 10 may include a plurality of functional modules comprising one or more computerized instructions that are stored in the storage system 15, and executed by the microprocessor 16 to perform operations of the BMC 13. In one embodiment, the PXE testing system 10 includes a DHCP service module 200, a parameter provision module 210, and a TFTP service module 220. In general, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

The DHCP service module 200 is operable to allocate an IP address for the NIC 11 by sending a DHCP offer message to the NIC 11 in response to receiving a DHCP discover message (DHCPDISCOVER) from the NIC 11. In one embodiment, the DHCP service module 200 may allocate the IP address for the NIC 11 using the DHCP service installed on the server 12. When the NIC 11 is connected to the server 12 and is activated, the NIC 11 may send the DHCP discover message to discover available DHCP services of the server 12. When the server 12 receives the DHCP discover message from the NIC 11, the server 12 reserves an IP address for the NIC 11 and provides the IP address to the NIC 11 by sending the DHCP offer message (DHCPOFFER) to the NIC 11. In other embodiment, the DHCP offer message may include a MAC address, the IP address that the server 12 is offering to the NIC 11, an IP address of the server 12, and other useful information, for example.

The parameter provision module 210 is operable to provide trivial file transfer protocol (TFTP) parameters to the NIC 11 by sending a DHCP acknowledgement (ACK) message to the NIC 11 in response to receiving a DHCP request message (DHCPREQUEST) from the NIC 11. In one embodiment, the TFTP parameters may include, for example, an IP address (e.g., 192.168.1.10), a port number (e.g., 09), a gateway (e.g., 192.168.1.1), and other network configuration information of the server. The DHCP request message is a response message of the DHCP offer message, and is sent from the NIC 11. The DHCP ACK message is a response message of the DHCP request message, and is sent from the server 12.

The TFTP service module 220 is operable to establish a connection based on a multicast trivial file transfer protocol (MTFTP) or a TFTP between the BMC 13 and the NIC 11 according to the TFTP parameters, and provide the PXE image file to the NIC 11 for downloading through the connection in response to receiving a request for downloading the PXE image file from the NIC 11, wherein the PXE image file is downloaded to a memory (e.g., a RAM, ROM, flash memory) of the server 12. The TFTP service module 220 is further operable to execute the downloaded PXE image file to test the PXE function of the NIC 11, and determine whether the PXE function of the NIC 11 is normal according to an execution result of the PXE image file. In one example, if a predetermined message, such as, “It is ok” is generated after the PXE image file is executed, the PXE function of the NIC 11 is determined to be normal. Otherwise, if the predetermined message is not generated after the PXE image file is executed, the PXE function of the NIC 11 is determined to be abnormal.

The TFTP service module 220 is further operable to generate a test result of the PXE function of the NIC 11 according to the determination. In the embodiment, the test result may indicate that the PXE function of the NIC 11 is normal or abnormal, and can be output to a display of the server 12.

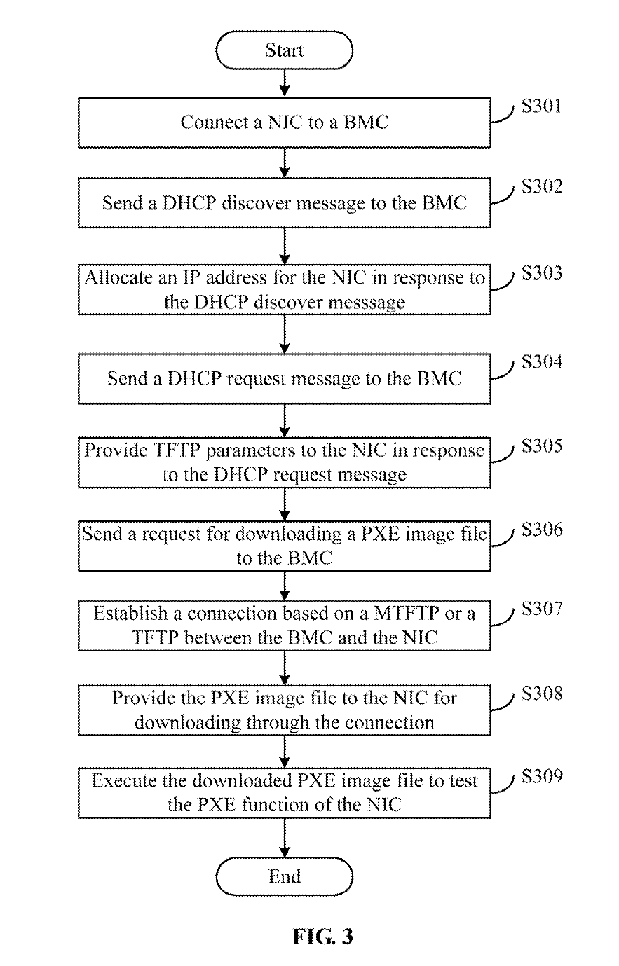

FIG. 3 is a flowchart of one embodiment of a method for testing a PXE function of a network interface card (NIC) of the server of FIG. 1. Depending on the embodiment, additional blocks may be added, others removed, and the ordering of the blocks, may be changed.

In block 5301, the NIC 11 is connected to the BMC 11 through the network interface 14 of the BMC 11.

In block 5302, the NIC 11 sends a DHCP discover message (DHCPDISCOVER) to the BMC 13 to search an available DHCP service installed on the server 12 if the server 12 is available. Details of the DHCP discover message are described above.

In block 5303, the DHCP service module 200 allocates an IP address for the NIC 11 by sending a DHCP offer message (DHCPOFFER) to the NIC 11 in response to the DHCP discover message. In one embodiment, the DHCP service module 200 may allocate the IP address for the NIC 11 using the DHCP service installed on the server 12. Details of the DHCP message are described above.

In block 5304, the NIC 11 sends a DHCP request message (DHCPREQUEST) to the BMC 13 in response to the DHCP offer message.

In block 5305, the parameter provision module 210 provides trivial file transfer protocol (TFTP) parameters to the NIC 11 by sending a DHCP acknowledgement (ACK) message to the NIC 11 in response to the DHCP request message. In one embodiment, the TFTP parameters may include, for example, an IP address (e.g., 192.168.1.10), a port number (e.g., 09), a gateway (e.g., 192.168.1.1), and other network configuration information of the server. The DHCP request message is a response message of the DHCP offer message, and is sent from the NIC 11. The DHCP ACK message is a response message of the DHCP request message, and is sent from the server 12.

In block 5306, the NIC 14 sends a request for downloading the PXE image file from the storage system 15 of the BMC 13.

In block 5307, the TFTP service module 220 establishes a connection based on a MTFTP or a TFTP between the BMC 13 and the NIC 11 according to the TFTP parameters.

In block 5308, the TFTP service module 220 provides the PXE image file to the NIC 11 for downloading through the connection in response to the request for downloading the PXE image file, wherein the PXE image file is downloaded to a memory (e.g., a RAM, ROM, flash memory) of the server 12 by the NIC 11.

In block 5309, the TFTP service module 220 executes the downloaded PXE image file to test the PXE function of the NIC 11, and determines whether the PXE function of the NIC 11 is normal according to an execution result of the PXE image. In one example, if a predetermined message, such as, “It is ok” that is generated after the PXE image file is executed, the PXE function of the NIC 11 is determined to be normal. Otherwise, if the predetermined message is not generated after the PXE image file is executed, the PXE function of the NIC 11 is determined to be abnormal. In addition, the TFTP service module 220 generates a test result of the PXE function of the NIC 11 according to the determination. Thus, the test result may indicate that the PXE function of the NIC 11 is normal or abnormal, and can be output to a display of the server 12.

Although embodiments of the present disclosure have been specifically described, the present disclosure is not to be construed as being limited thereto. Various changes or modifications may be made to the present disclosure without departing from the scope and spirit of the present disclosure.

What is claimed is:

1. A method for testing a preboot execution environment (PXE) function of a network interface card (NIC) of a server using a baseboard management controller of the server, the method comprising:
allocating an IP address for the NIC by sending a DHCP offer message to the NIC in response to receiving a DHCP discover message from the NIC;
providing trivial file transfer protocol (TFTP) parameters to the NIC by sending a DHCP acknowledgement (ACK) message to the NIC in response to receiving a DHCP request message from the NIC;
establishing a connection based on a multicast trivial file transfer protocol (MTFTP) or a TFTP between the BMC and the NIC according to the TFTP parameters;
providing a PXE image file to the NIC for downloading through the connection in response to receiving a request for downloading the PXE image file from the NIC, wherein the PXE image file is downloaded to a memory of the server; and
executing the downloaded PXE image file of the memory to test the PXE function of the NIC; and
generating a test result of the PXE function of the NIC by determining whether the PXE function of the NIC is normal according to an execution result of the PXE image file.

2. The method according to claim 1, wherein the IP address is allocated for the NIC using a DHCP service installed on the server.

3. The method according to claim 1, wherein the TFTP parameters comprise an IP address, a port number, and a gateway of the server.

4. The method according to claim 1, wherein the PXE image file is prestored in a storage system of the BMC.

5. The method according to claim 1, wherein the NIC is connected to the BMC through a network interface of the BMC.

6. A server, comprising:
a baseboard management controller (BMC) comprising a microprocessor and a storage system; and
one or more programs stored in the storage system and being executable by the microprocessor, the one or more programs comprising:
a DHCP service module operable to allocate an IP address for the NIC by sending a DHCP offer message to the NIC in response to receiving a DHCP discover message from the NIC;
a parameter provision module operable to provide trivial file transfer protocol (TFTP) parameters to the NIC by sending a DHCP acknowledgement (ACK) message to the NIC in response to receiving a DHCP request message from the NIC; and
a TFTP service module operable to establish a connection based on a multicast trivial file transfer protocol (MTFTP) or a TFTP between the BMC and the NIC according to the TFTP parameters, provide a PXE image file to the NIC for downloading to a memory of the server through the connection in response to receiving a request for downloading the PXE image file from the NIC, execute the downloaded PXE image file to test the PXE function of the NIC, and generate a test result of the PXE function of the NIC by determining whether the PXE function of the NIC is normal according to an execution result of the PXE image file.

7. The server according to claim 6, wherein the IP address is allocated for the NIC using a DHCP service installed on the server.

8. The server according to claim 6, wherein the TFTP parameters comprise an IP address, a port number, and a gateway of the server.

9. The server according to claim 6, wherein the PXE image file is prestored in a storage system of the BMC.

10. The server according to claim 6, wherein the NIC is connected to the BMC through a network interface of the BMC.

11. A non-transitory storage medium storing a set of instructions, the set of instructions capable of being executed by a microprocessor of a baseboard management controller (BMC) of a server, causes the BMC to perform a method for testing a preboot execution environment (PXE) function of a network interface card (NIC) of the server, the method comprising:
allocating an IP address for the NIC by sending a DHCP offer message to the NIC in response to receiving a DHCP discover message from the NIC;
providing trivial file transfer protocol (TFTP) parameters to the NIC by sending a DHCP acknowledgement (ACK) message to the NIC in response to receiving a DHCP request message from the NIC;
establishing a connection based on a multicast trivial file transfer protocol (MTFTP) or a TFTP between the BMC and the NIC according to the TFTP parameters;
providing a PXE image file to the NIC for downloading through the connection in response to receiving a request for downloading the PXE image file from the NIC, wherein the PXE image file is downloaded to a memory of the server; and
executing the downloaded PXE image file of the memory to test the PXE function of the NIC; and
generating a test result of the PXE function of the NIC by determining whether the PXE function of the NIC is normal according to an execution result of the PXE image file.

12. The non-transitory storage medium according to claim 11, wherein the IP address is allocated for the NIC using a DHCP service installed on the server.

13. The non-transitory storage medium according to claim 11, wherein the TFTP parameters comprise an IP address, a port number, and a gateway of the server.

14. The non-transitory storage medium according to claim 11, wherein the PXE image file is prestored in a storage system of the BMC.

15. The non-transitory storage medium according to claim 11, wherein the NIC is connected to the BMC through a network interface of the BMC.
